(19) United States
(12) Patent Application Publication
(10) Pub. No.: US 2018/0193899 A1
(43) Pub. Date: Jul. 12, 2018

(54) FERROMAGNETIC SHEET FANNING AND GRIPPING DEVICE

(71) Applicant: Magswitch Technology Europe GmbH, Ingolstadt (DE)

(72) Inventor: Cengitz KIZILKAN, Ingolstadt (DE)

(21) Appl. No.: 15/564,195

(22) PCT Filed: Apr. 7, 2016
(86) PCT No.: PCT/EP2016/057617

§ 371 Date: Oct. 3, 2017

(30) Foreign Application Priority Data
Apr. 8, 2015 (DE) 10 2015 004 277.7

(51) Int. Cl. B21D 43/24; B21D 43/18; B65H 3/16; B65H 3/60; B65G 59/04; B21D 43/00

(52) U.S. Cl. CPC B21D 43/24; B21D 43/18; B65H 3/16; B65H 2701/173; B65G 59/04; B21D 43/003; B65H 2701/1714; B65H 3/60

(57) ABSTRACT

A device for separating and gripping an outermost sheet of ferromagnetic material from a stack of ferromagnetic sheet material, comprising:
a carrier structure with a mount for attaching the carrier as an end-of-arm-tool (EOAT) to a robotic arm arranged for moving and positioning the device into an operating position adjacent a side of a stack of ferromagnetic sheets and a remote position removed from the stack of ferromagnetic sheets;
a magnetic fanning apparatus mounted at the carrier structure and having a switchable magnet and a pair of fanning pole shoes magnetisable by the magnet with opposite polarities, the fanning pole shoes located at the carrier such that when in the operating position of the device these face the side of stacked sheets and extend over the thickness of at least the outermost and an underlying sheet of the stack, whereby in an on state of the magnet magnetic fields of like polarity are induced by the fanning pole shoes in overlapping sections of edge regions of these sheets and repulsive forces are generated whereby the outermost sheet seeks to lift away from the underlying sheet by magnetic repulsion; and preferably but optionally
a sheet gripping apparatus mounted at the carrier structure arranged for contacting a face of the outermost sheet and secure the sheet to the EOAT for retrieval thereof upon the device being displaced from its operative position away from the stack of sheets.

### FIELD OF THE INVENTION

The present invention relates generally to material handling equipment and in particular to magnetic devices for separating one or more ferromagnetic sheets from a stack of such sheet material.

### BACKGROUND TO THE INVENTION

When handling and conveying ferromagnetic sheet material, often but not always flat sheets, see below, it is often necessary to lift/remove single sheets from a horizontal stack of sheets and convey them to a work station for further processing.

In particular in the automotive manufacturing sector it is practice to stamp/draw/cut/flange individual chassis and bodywork panels from flat metal sheets, which panels are then stacked and transported in bulk to a vehicle body assembly line and/or sub-assembly stations or lines. Crates of the stacked panels that are to be assembled into vehicle body sub-units at dedicated assembly stations (eg doors at a door assembly station) or incorporated into the vehicle body being formed as it traverses assembly stations along a moving assembly line, are delivered and placed in the periphery of the assembly jig or dedicated fitment stations along the assembly line, and individual panels are then removed from the stacks, placed in the jigs and other positioning fixtures where the panels are then joined into a vehicle body components or the vehicle frame/chassis. Joining can be effected by welding, hemming and other well known operations.

Separating the top most sheet from a stack of horizontally stacked sheets without also removing the penultimate sheet can be problematic. This is in particular the case where oils or other liquids at the sheet surface can cause sheets to ‘stick’ to one another.

To address this problem, in particular for delivering individual sheets from a stack of flat sheet material, but also involving pre-shaped and drawn panels having a large surface area, various types of sheet separators have been developed.

There are separator devices that use gravitational forces and movable support platforms with traverse pushers/plungers whose relative displacement to each other is sequenced to fan out one or more sheets from the stack, such as describe for example in U.S. Pat. No. 4,544,315.

Magnetic separator devices for fanning out individual sheets from the top (or bottom) of a stack of flat sheet metal blanks are also know. Such devices are described for example in U.S. Pat. Nos. 2,541,985, 2,650,092 and 2,973,959.

Perhaps illustratively best explained in U.S. Pat. No. 2,973,959 (Stolk), and broadly speaking, such devices use one or more magnets (either electro or permanent magnets) that are associated with at least two passive magnetic material pole shoes or rails that can be magnetised with opposite polarity to each other, and which can be located adjacent an edge (or side) of the stack of sheets. When magnetised, the pole shoes in turn extend the magnetic field(s) of the magnet(s) into the stack of ferromagnetic sheet material. The magnetic fluxes induced in the edge regions of the stacked sheets are of same direction (extending between the N-S magnetised pole shoes), and thus repelling magnetic forces are induced in the sheets in the stack in a direction generally perpendicular to the flux path, thus tending to separate the top most stacked sheets fan-like from one another. Sheet fanning devices using this basic principle of operation fall into two main categories:

In the first category, a large vertical stack of magnets is positioned adjacent one side of a vertical stack of ferromagnetic sheets. The vertical stack of magnets extends the entire height of the stack of sheets and thus can induce a strong magnetic polarity in a vertically aligned edge portion of each sheet. This provides a powerful and consistent magnetic force seeking to fan out and separate the sheets within the stack. Typically, the magnets in the stack are fixed in place, or alternatively they are retractable away from an outer surface of the fanning device which faces the sheet stack. Retractable magnets provide more control of the fanning process and improved safety.

In the second category, a relatively small magnet, but otherwise having appropriate magnetic specifications, is placed close to the side edges of the upper most sheets of the stack. This fans out the top few sheets of the stack so that the topmost sheet can be lifted away. As successive topmost sheets are removed, the magnet moves down a vertical guide to be level with the next topmost sheet in the stack, so as to fan subsequent sheets as these are intended for removal.

Devices of the type using the large vertical stack of magnets have several inherent drawbacks. Assembling a large number of magnets in the required orientation along a vertical support structure is difficult, in particular due to the magnetic repulsion between each individual magnet. Spacing between magnets can address this, but this in turn diminishes fanning efficiency. Furthermore, the costs associated with the number of magnets required to fan out larger stacks, is significant. Safety is also an issue with these types of sheet fanning devices, even if the magnets are retractable. Magnetic devices of this type are not considered to be truly safe and are notoriously difficult to clean and maintain.

Fanning apparatus with small vertically moveable magnets address most of the above drawbacks but also have their own disadvantages. Fanning devices of this kind have relatively limited power (compared to the large vertical stack of magnets) and tend not to operate well with stacks of poorly aligned sheets or low strength ferromagnetic materials. This places inherent restrictions on the sheet thickness and size suitable for this type of fanning device.

Regardless of which type of device is used, both categories have some common disadvantages. Both types require mounting fixtures that consume valuable floor space immediately adjacent the stack. The installation of these fixtures must be solid and secure in view of the strong magnetic forces involved, and the weight of the stack of sheets. Such installations are difficult to move or redeploy during any retooling or rearrangement of the equipment.

Relevantly, both types of device are separate and distinct from a primary sheet lifting and retrieval tool and as such are an additional piece of equipment requiring purchase, installation and maintenance.

In many modern automotive assembly lines and stations, transport and handling of flat and formed metal sheets, panels and components is effected using robots, in particular using vacuum or mechanical gripping tools supported at the end of a robotic arm or gantry (so called end of arm tools, EOAT). Magnetic EOATs have also found application.

For example, U.S. Pat. No. 8,702,078 B2 describes a magnetic EOAT that can be coupled to a robot arm for manipulating ferromagnetic work pieces. In this US document, the magnetic EOAT has a magnetic member adjustably coupled to a housing and adapted to be magnetically attached to the work piece, the magnetic member providing a selective variable magnetic force in respect of the metallic work piece. When mounted to a multi-position robot arm, the EOAT can be located against and magnetically coupled to door, hood, trunk or other vehicle structures that are movably mounted to the main body frame of the vehicle. In this manner, the EOAT can be used to change position of the movable parts thereby facilitating access to interior surfaces in the process of body work painting on the vehicle assembly paint line, for example.

A magnetic EOAT such as the above described one could equally be used to magnetically grip a topmost sheet metal part on a stack of such parts for the purpose of subsequent transport to another location.

However, the above described problem of de-stacking the uppermost from the next sheet metal panel remains alive, ie how to address the adhesive tension between stacked sheet-like ferromagnetic panels. Laypeople would fail to appreciate that in seeking to provide magnets of suitable rating to overcome the adhesion forces between stacked sheets of ferromagnetic material, ie magnets with sufficient ‘pulling’ power, magnetic saturation of ferromagnetic sheet material, which is a function of the magnetic properties of the material and the thickness of the sheets/panels, in the typically strong magnetic fields required for such purpose, will actually lead to magnetic clamping of stacked sheets to one another, rather than allowing removal of the outermost sheet only.

Consequently, ferromagnetic sheet material handling stations that use magnetic grippers (lifting devices) to vertically remove and lift an uppermost sheet from an essentially horizontal stack of sheets, use a separate sheet fanning station of the types described above. Such magnetic fanners are placed next to the stacked sheets, to assist in the de-stacking operation. This is indeed the approach used in 2010 at the Tower Automotive plant in Elkton, Mich. (USA), where in addition to a magnetic EOAT lifting unit, comprising multiple discrete magnets to engage sheet metal pieces, a traditional sheet fanning station is used, https://www.magnetics.com/downloads/pdf/IMITower.pdf.

Noting the above described shortcomings of traditional sheet fanning satations, apparatus and devices, one object of the present invention is to make available a magnetic fanning arrangement or device which assists de-stacking of sheet metal components and which is more compact than the stations/installations provided in the prior art.

Another object is to provide a magnetic fanning apparatus that may find use in a magnetic EOAT.

### SUMMARY OF THE INVENTION

In seeking to address these aims, in one aspect, the present invention provides, in a broad incarnation, a sheet fanning device for use in fanning-away an outer most sheet from a stack of ferromagnetic sheet material, comprising:
a carrier structure with a mount for attaching the carrier as an end-of-arm-tool (EOAT) to a robotic arm arranged for moving and positioning the EOAT between an operating position adjacent a side of a stack of ferromagnetic sheets and a remote position removed from the stack of ferromagnetic sheets; and
a magnetic fanning arrangement supported by the carrier structure, the fanning arrangement comprising at least one on-off switchable magnet and a pair of fanning pole members magnetisable by the switchable magnet with opposite polarities, the fanning pole members spaced apart and configured such that when in the operating position of the EOAT these face the side of the stack and dimensionally extend over a length comprising the thickness of at least the outermost and an underlying sheet of the stack, the switchable magnet being switchable into an on state in which magnetic fields of like orientation are induced by the fanning pole shoes in overlapping sections of edge regions of the outermost and the next underlying sheet and repulsive forces are generated in a direction perpendicular to the induced magnetic fields, seeking to lift the edge region of the outermost sheet away from the underlying sheet by magnetic repulsion; and preferably but optionally
a sheet gripping arrangement supported at the carrier structure and arranged for contacting a face of the fanned-out outermost sheet and secure this sheet to the EOAT for retrieval thereof upon the EOAT being displaced from its operative position away from the stack of sheets.

With the present invention, a direct integration of a magnetic fanning device into a robotic end-of-arm-tool (or tooling) is provided, whereby a suitable sheet gripping device is equally integrated into a preferred embodiment of such EOAT.

Preferred embodiments of the present invention have been developed in accordance with the first aspect to allow de-stacking of sheets and panels having a relatively large-surface-area (eg 0.6 to 1.6 square meters) and made of relatively thin gauge ferromagnetic sheets (sheet thickness; 0.4 to 1.2 mm) typically used in the manufacture of automotive body panels. Due to the relatively high flexibility traverse to the main plane of extension of such panels, once the adhesive coupling at the edges of the stacked panels is overcome through the use of the fanning device component, ‘peeling’ (bending) moments will assist in overall de-stacking through the gripping device.

It will be understood that the term ‘sheet’ as used herein and in the claims appended hereto, denotes not only bi-directionally planar sheets and panels of thin gauge ferromagnetic materials, but equally uni-axially or bi-axially curved sheets and panels as used in the manufacture of complex structures such as car bodies, machine housings, box-like structures and many more engineering structures.

The sheet gripping arrangement can be a state of the art suction cup device or a conventional mechanical gripper used to secure sheet metal and remove it from a stack of sheets.

However, in a preferred form, the sheet gripping arrangement also utilises the or another switchable magnet arrangement to magnetically attach to the face of the outermost sheet and secure the magnetically fanned-off outermost sheet to the EOAT, as will be explained below by way of a preferred but not exclusive embodiment of a magnetic gripping device which cooperates with the magnetic fanning device.

In another, more preferred aspect of the present invention, there is provided a magnetic sheet fanning and gripping device for magnetically fanning and gripping an outermost ferromagnetic sheet material from a stack of such sheets, comprising: a support structure with a coupling for releasable securing of the fanning and gripping device as an end of arm tool (EOAT) to a positioning device, such as for example a multi-motion robotic arm, used to bring the fanning and gripping device in alignment with a lateral side of a stack of ferromagnetic sheets; a pair of ferromagnetic fanning pole shoes carried by the support structure, each fanning pole shoe having a longitudinal extension sufficient to dimensionally span at least the combined thickness of the outermost two sheets of the stack when brought in facing relationship at the side of the stack; a pair of ferromagnetic gripping pole shoes carried by the support structure, each gripping pole shoe having an abutment face angled with respect to the longitudinal extension of the fanning pole shoes and of a length sufficient to span over an edge zone of the sheets, the abutment face operative to receive and magnetically secure the outermost sheet of the stack to the support structure; and an on-off switchable magnet arrangement carried by the support structure and switchable for magnetizing one of the pole shoes from each of the pair of fanning and gripping pole shoes with the same polarity and the other one of the pole shoes of each of the pairs to have the opposing polarity; wherein the device is operative to (i) induce a north-south magnetic field in the edge regions of at least the outermost and its underlying sheet in the stack when the pair of fanning pole shoes are brought in close facing relationship with the edges of the stack and the magnet arrangement in an on-state, (ii) set up repulsive forces between the outermost and its underlying sheet in the stack and fan (separate) the outermost sheet from the stack along the longitudinal extension of the fanning pole shoes and (iii) urge the outermost sheet into contact with the abutment faces of the gripping pole shoes which hover over the stack, thereby magnetically securing the outermost sheet to the device. The sheet can then be lifted completely from the stack upon displacement of the fanning and gripping device by the positioning device.

By configuring the EOAT device to not only magnetically fan-out the outer most sheet but also contact the surface of the outermost sheet and magnetically secure the sheet to the EOAT, magnetic sheet fanning and gripping functionalities are effectively integrated into a single device of compact layout. As a single piece of equipment, the costs and maintenance of a stand alone sheet fanning device are avoided. Furthermore, if the magnetic device is provided on a robotic arm as an end-of-arm tool (EOAT), rearrangement or repositioning of the device is far simpler and quicker. Furthermore, if the robotic arm is mounted to the ceiling or a gantry, no additional floor space is consumed.

Preferably, the on-off switchable magnet arrangement utilises one or more switchable permanent magnet units of the type or similar to the types manufactured and sold by Magswitch Technology, Inc. under the “M” and “AR” series, see www.magswitch.com.au.

Such switchable magnet units comprise two cylindrical, diametrically polarised rare earth permanent magnets, stacked about a housing axis and received for relative rotation within a cylindrical cavity of a special-purpose housing. The latter is designed to provide itself N- and S passive ferromagnetic material pole extension components for the magnetic-active material permanent magnets. The housing is furthermore shaped to allow attachment of differently shaped additional pole (extension) shoes, ie the fanning and gripping pole shoes, to the switchable magnet units, as noted below in the context of a preferred embodiment. For further details refer to the magswitch website and/or earlier patent documents of magswitch group companies, in particular WO 01/43147 A1, U.S. Pat. No. 6,707,360 B and U.S. Pat. No. 7,012,498 B, the contents of which are incorporated herein by way of short hand cross-reference.

In a preferred form, the on-off switchable magnet arrangement will comprise a single magnet unit providing the source of magnetic field for both the fanning and gripping functionalities of the device. In that case, the fanning as well as the gripping (or attachment) pole shoes can advantageously be provided by a single pair of L-shaped pole shoes formed from ferromagnetic steel, one L-shaped shoe secured and interacting with the switchable magnet unit to provide an N-pole extension element, and another (identical) L-shaped shoe providing the S-pole extension element when the magnet is in its on state (ie an external magnetic field is present). The L-shaped pole shoes are secured (with the magnet unit) at the carrier structure such that during use, a specific orientation of the arms of the L-pole shoes is given when the device is in its operative position next to the stack of sheets. If the stack comprises horizontally stacked sheets, the sheet edges will extend horizontally and the side of the stack will be vertical. Accordingly, in this case, the operating position will dictate that one arm of the L-shaped pole shoes will extend generally vertically and parallel to the side (face) of the stack, ie provide the fanning pole shoes, for directing magnetic flux into a section of the edges of the sheets close to the top of the stack. The other arms, which preferably extend perpendicular to the fanning pole shoe arms, or with a slight angular offset from the perpendicular orientation, will then provide the gripping pole shoes.

In an alternate embodiment, the on-off switchable magnet arrangement may comprise two of the above mentioned magswitch units, independently operable, if desired, for enhanced and separate control of the sheet fanning and gripping functionalities of the device. Of course, a suitable drive train may be provided at the EOAT to switch both the fanning and gripping magnet units on and off simultaneously.

In a particularly preferred form, the displacement device is a robotic arm and the fanning and gripping device is an end-of-arm tooling for mounting to the robotic arm.

Preferred embodiments of the present invention will now be described by way of example only with reference to the accompanying drawings. Additional features and preferred aspects of the invention may also be gleaned from the following description.

### BRIEF DESCRIPTION OF THE DRAWINGS

FIG. 1 is a schematic representation of a ferromagnetic sheet material handling station that includes as an EOAT a fanning and gripping device according to one embodiment of the invention, mounted to an overhead positioning apparatus;

FIG. 2a is an exploded perspective view of a first embodiment of a magnetic fanning and gripping device of the invention, as can be used in the station of FIG. 1, schematically showing the magnetic unit of the device in a magnetic on state;

FIG. 2b is the fully assembled perspective view of the magnetic device shown in FIG. 2a, but schematically showing the magnetic unit of the device in an off state;

FIG. 3a is a partially exploded perspective view of a second embodiment of a magnetic fanning and gripping device of the invention, as can be used in the station of FIG. 1;

FIG. 3b is the fully assembled perspective view of the magnetic device shown in FIG. 3a;

FIG. 4 shows the magnetic device of FIG. 2a located at the side of and next to a stack of sheet material from which an uppermost sheet is to be removed;

FIGS. 5a to 5d are schematic and simplified views to illustrate the mode of operation of the fanning and gripping device of FIGS. 2 and 4 (but equally FIGS. 3a, 3b), wherein FIG. 5a shows a schematic and partial side elevation of one of the pole extension members of the device of FIG. 4 (thus omitting the other components of the device) adjacent the stack of ferromagnetic sheets, FIG. 5b shows a schematic plan view of the magnetic interaction between the (fanning) pole extension shoes of the magnetic device of FIG. 4 and a sheet within the stack, FIG. 5c is a schematic representation similar to FIG. 5a but in which the sheet edges begin to separate (fan out) due to magnetic repulsive forces induced by the magnetic fields in the sheets projected by the fanning portions of the pole extension members, and FIG. 5d is a schematic representation similar to FIGS. 5a and 5c with the topmost sheet engaging the gripping portion of the pole extension members of the magnetic device of FIG. 4.

FIG. 6 is a side elevation of a third, two-magnet unit embodiment of a magnetic fanning and gripping device in accordance with the invention, for use in the sheet separating and lifting device of FIG. 1, schematically illustrating fanned sheets of a stack of metal sheets;

FIG. 7 is a perspective view of the magnetic device shown in FIG. 6; and

FIG. 8 is a perspective view of another two-magnet embodiment of a magnetic fanning and gripping device in accordance with the invention.

### DETAILED DESCRIPTION OF PREFERRED EMBODIMENTS

Throughout the specification, terms such as ‘upper’, ‘lower’, ‘left’, ‘right’, ‘longitudinal’, ‘vertical’, ‘side’, ‘topmost’, ‘bottommost’ and other terms denoting relative orientation and relative positioning are used in the context of the accompanying figures and to facilitate a proper understanding of the relative arrangement and interaction of the various component parts and features. The skilled worker will readily appreciate the use of such terms in no way impart any particular limitation on those features to which the terms relate.

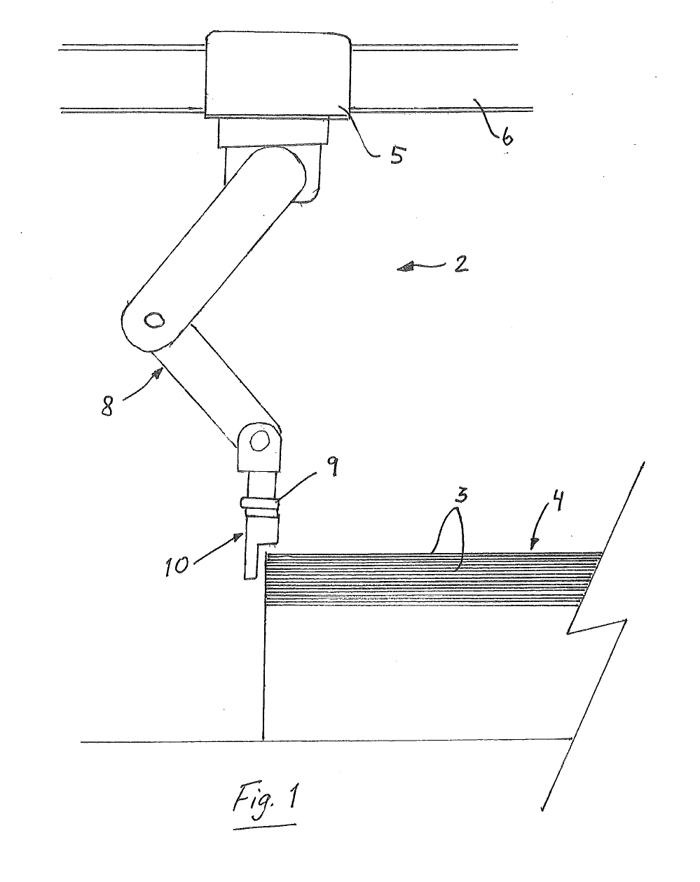

FIG. 1 shows schematically part of a sheet material handling station 2 which is used for removing ferromagnetic material sheets or panels 3 from a stack 4 in which such sheets 3 are stacked in essentially parallel-horizontal planes. The sheets 3 need not be planar but may be curved in one or two extensions of the sheet, and may be more complex in topography, such as car body panel sheets, but would be stacked horizontally one above the other.

Handling station 2 comprises a carriage unit 5 received for linear displacement along an overhead gantry beam 6, a multi-limb, multi-axis robotic arm 8 suitably supported and articulated at carriage unit 4, and a coupling unit 9 at the terminal free end of the robotic arm 8. Coupling unit 9 is devised for removably mounting, as is known in the art, modular EOATs 10 using coupling components not shown but known in the relevant art of robotics and automation. Control and power supply lines have been omitted for clarity purposes.

Robotic arm 4 is shown suspended from carriage unit 5 but could equally be floor (pedestal) mounted, as is also well known. Suspending robotic arm 4 from an overhead gantry 6 does not require any plant floor space in vicinity of sheet stack 4, and hence has the advantage of providing increased flexibility of operation at the sheet metal handling station 2 for placing the stack and then removing individual sheets 3 and conveying these to a work station for machining, forming, assembly with other parts, etc.

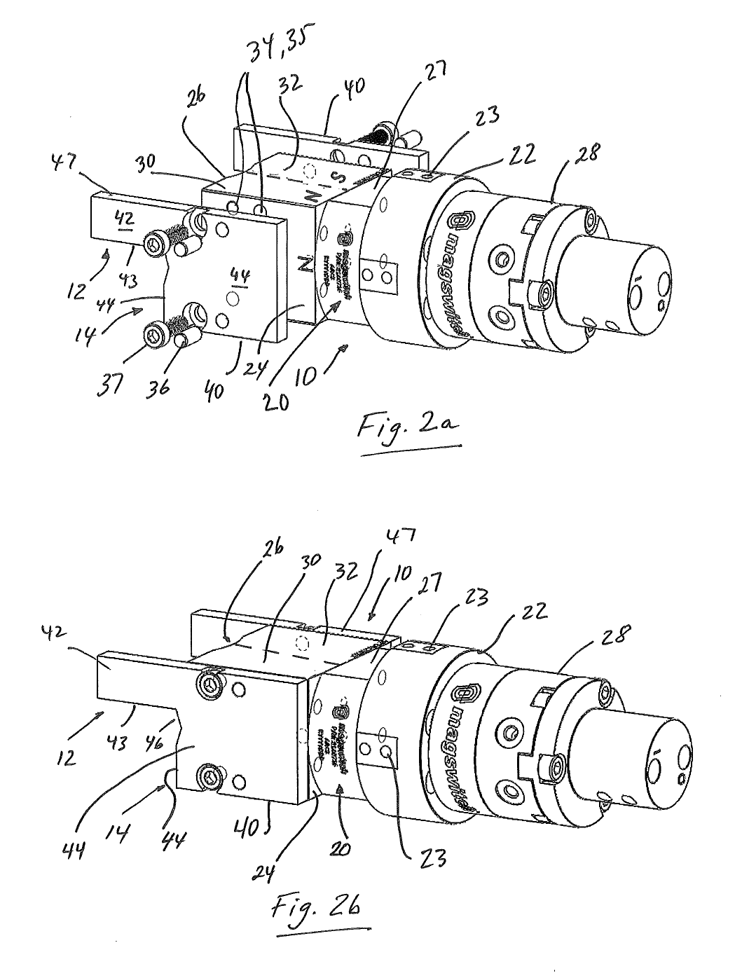

Various embodiments of EOATs 10, 100, 200, 300 in accordance with the present invention, and as utilised in station 2, are illustrated in FIGS. 2a/2b, 3a/3b, 4, and 6 to 8. EOATs 10, 100, 200, 300 as per the various embodiments of the invention comprise primarily a magnetic sheet fanning device (or functional arrangement) 12 which aids in de-stacking individual sheets 3 from stack 4, but also integrate a top sheet gripping device (or functional arrangement) 14 enabling the top most sheet 3 in the stack 4, which is initially ‘fanned away’ from the remainder of the stacked sheets 3, to be magnetically grabbed at the upper face close to the fanned-off edge to assist in removing the sheet from stack 4, as explained in more detail below.

It is conceivable for handling station 2 to have multiple robotic arms suspended from respective carriage units that are in turn supported at the gantry beam, with each robotic arm carrying identical EOATs 10 at their terminal ends, allowing placement of separate EATOs at each of the four sides of a stack of quadrilateral sheets, to jointly perform a top sheet fanning and grabbing operation, whereby the magnetically suspended sheet can then be lifted away from the stack, by ‘un-peeling’ the edge zones of the top sheet from the immediately next lower sheet, thus facilitating breaking of the adhesive tension between the two uppermost stacked sheets upon lifting off the EOATs away from the stack.

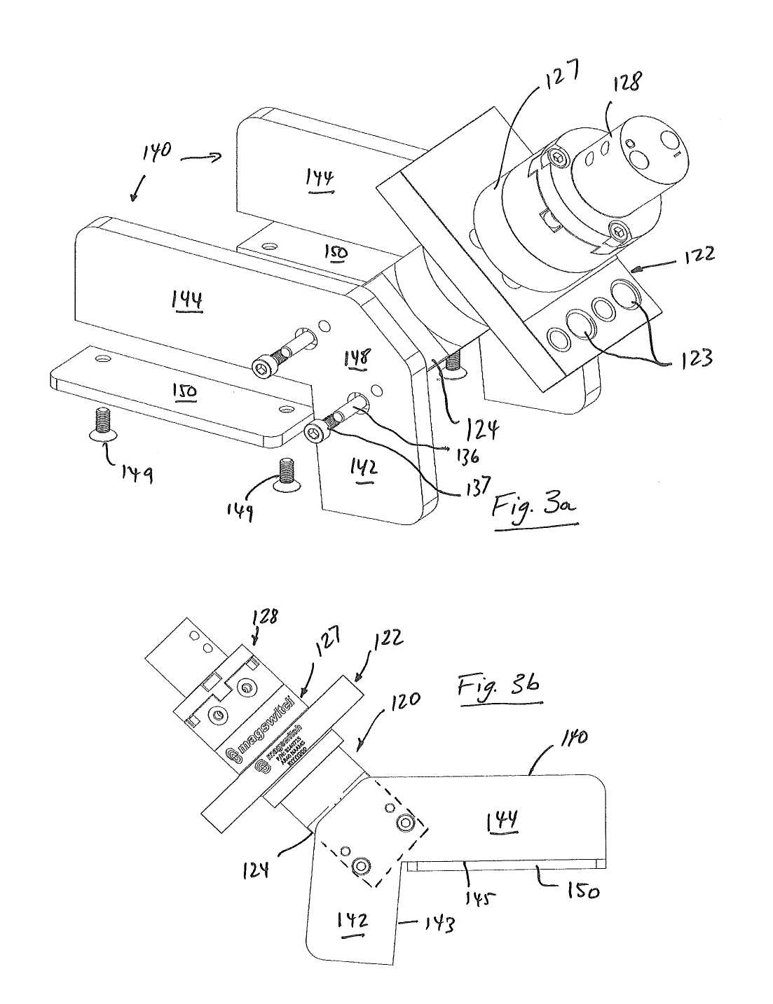

Turning then first to FIGS. 2a, 2b and 3a, 3b, these illustrate two generally functionally and constructionally similar embodiments of EOATs 10 and 100 in accordance with the invention. Consequently, double digit reference numbers identifying components and parts in the first embodiment are expanded to triple digit reference numbers, in the 100 series, to identify functionally similar components and parts. Consequently also, a detailed description will be omitted for components and parts illustrated but not necessarily referenced in FIGS. 3a and 3b which have a similar function and lay-out to components present in and described with reference to FIGS. 2a and 2b.

The EOATs 10, 100 comprise, essentially, an on-off switchable permanent magnet unit 20, 120, a mounting or support structure (supporting ring 22 with threaded mounting bores 23 in FIG. 2 and supporting plate 122 with various through-bores for fastening bolts in FIG. 3) by way of which the EOAT 10, 100 can be removably secured to suitably configured support components of coupling unit 9 at robotic arm 8, and two identically shaped and configured pole extension members (also called shoes in magnetic circuits) 40, 140 made from passive ferromagnetic material and which are mounted to permanent magnet unit 20, 120 to provide magnetic field guides as is described below.

The on and off switchable permanent magnet unit 20, 120 in the illustrated embodiments is a Type AR or M switchable magnetic unit as manufactured and sold by Magswitch Technology Inc., of Colorado, USA.

For present purposes it should suffice to describe magnet units 20, 120 as comprising a cube-shaped housing block 24, 124 having a cylindrical through-bore in which is housed a non-displaceable cylindrical, diametrically magnetized di-pole permanent magnet and a cylindrical, diametrically magnetized di-pole permanent magnet (of equal magnetic specification) that is stacked on top of the fixed magnet in a manner that allows rotation thereof about a longitudinal axis of the bore. The di-pole magnets are rare-earth type magnets.

The housing block 24, 124 is made from ferromagnetic material and fashioned to have two magnetically isolated side wall portions 30, 32 which thus define integral passive pole extension members 30, 32 for the active N- and S-poles of the cylindrical magnets of the unit 20, 120. These integral passive poles 30, 32 (also present in the embodiment of FIGS. 3a/3b, but not identified) serve to receive and guide/channel the magnetic flux (and magnetic field lines) originating from/terminating in the permanent magnets towards/from the working air gap of the units 20, 120 defined at the free terminal axial end face 26 of housing block 24, 124, when the permanent magnets are switched into an on-state of unit 20, 120, as described below.

The rotatable one of the magnets is coupled via an intermediate actuation module 27, 127 flanged to a rearward end of housing block 24, 124 to a step-actuator or motor 28, 128 mounted to ring mount 22/plate mount 122. Step motor 28, 128 is dimensioned to impart sufficient torque for rotating the rotatable permanent magnet in controlled manner between on and off states of the unit 20, 120, ie an on state in which the magnet unit 20, 120 exhibits an external magnetic field at the working air gap of the unit 20, 120, and an off state in which the magnetic fields of the two cylindrical magnets are confined within the housing block 22, 122, respectively.

The on switching state is characterised by the N- and S-poles of both cylindrical di-pole magnets ‘aligning’ (ie being superimposed when viewed along the stacking axis) and positioned to accordingly N- and S polarize the respectively facing side wall portions 30, 32 of housing block 24, 124 that provide the integral passive pole extension members of unit 20, 120, as schematically hinted in FIG. 2a by identifying N- and S-polarized sides of the housing block 24. The off switching state is characterised by the cylindrical magnets being 180°-rotationally inversed from the on position, ie the N-pole of one magnet aligns with the S-pole of the other magnet and the S-pole of the one magnet aligns with the N-pole of the other magnet, so that there is no magnetic field available for ‘tapping’ at the working air gap 26 and the side wall portions 30, 32 are not N-S polarized, as schematically hinted in FIG. 2b by the absence of N and S pole notations.

For further technical details as to the specific components and the basic operation of such units 20, 120, reference should be had to the document “MIS Operations and Design Guidelines—110636, revision date August 2013” published and available at http://magswitch.com.au/technical-information/, and U.S. Pat. Nos. 6,707,363 and 7,012,495 and WO 2010135788 A1 assigned to Magswitch Technology Worldwise Pty Ltd, the contents of which are hereby incorporated by cross reference.

It is preferred to employ AR-type magnet units 20, 120 given that these have a housing block 24, 124 already configured for removably attaching thereto ‘external’ passive pole extension shoes or components that are interchangeable, such as the passive ferromagnetic material pole extension members 40, 140 described above. This is perhaps best seen in FIG. 2a. To provide suitable mounting means, the two side wall portions 30, 32 of housing block 24 (but equally housing block, 124), which provide the ‘integral’ passive pole extension members of unit 20, 120 at opposite sides thereof, are provided with locating blind holes 34 and threaded fastening bores 35 which serve to receive, locate and secure locating pins 36, 136 and fastening bolts 37, 137 employed to secure the external (and thus, additional) pole extension members 40, 140 which provide the below detailed magnetic sheet stack fanning and uppermost sheet gripping functionalities of the EOAT 10, 100.

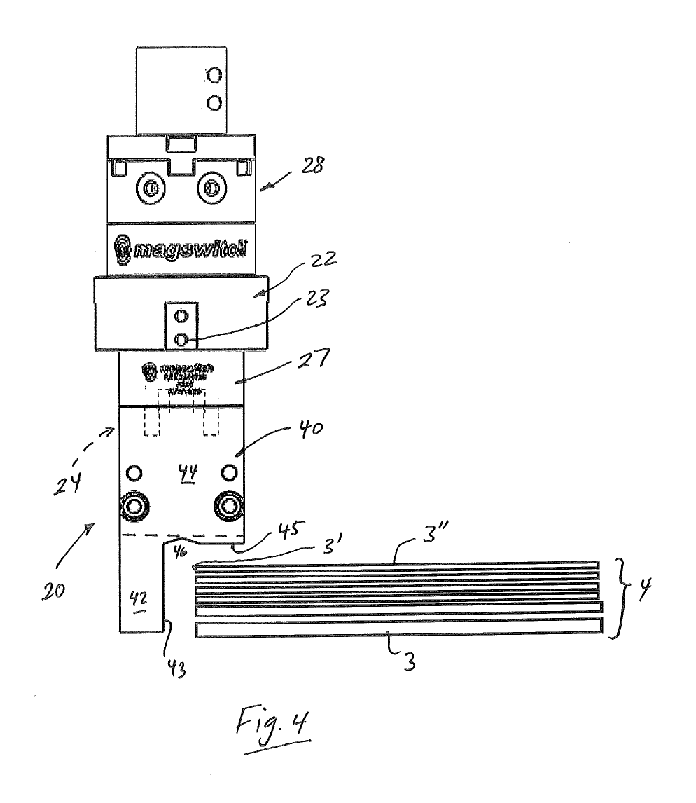

In the embodiment illustrated in FIGS. 2a, 2b and 4, pole extension members 40 are each comprised of identical (in plan view) L-shaped ferromagnetic plates having a longer but narrower first leg portion 42 and a shorter but wider and squatter second leg portion 44, wherein the converging side edges 43 and 45 of leg portions 42 and 44 extend perpendicular to each other and define at their juncture an about triangular indent 46 instead of a 90° corner.

As may be seen from FIG. 4, squat leg portion 44 is of such plan view dimensions and shape as to completely cover the side face of the cross-sectionally quadrilateral housing block 24 to which it is secured gap-free and in magnetic flux-conducting manner; whereby edge 43 will be located a little beyond the air gap 26 of unit 20. The presence of through holes 47, 48 for locating pin 36 and fastening bolt 37 to secure plates 40 to the outside of housing block 28 will be noted in FIG. 2a.

In contrast, first leg portion 42 of pole extension member 40 projects perpendicular from second leg portion 141 and protrudes substantially beyond the terminal end face (air gap 26) of housing block 24, finger like. It will be noted also that L-shaped pole extension members 40 are so mounted to housing block 24 that the first, finger-like leg portion protrudes about parallel to a longitudinal axis of the unit 20, with the outer edge 47 of finger-like portion 42 being about flush with the external face of housing block 24.

In the embodiment illustrated in FIGS. 3a and 3b, the external pole extension members 140 are also generally L-shaped ferromagnetic material plates with a shorter leg portion 142 and a longer leg portion 144. However, the external plan-view dimensions of pole plates 140 are substantially larger than those of the pole plates 40 shown in FIGS. 2a, 2b and 4, and the location of the fastening and locating holes 134, 135 for the locating pins 136 and fastening bolts 137, respectively, while maintaining the same overall relative configuration, is modified such that switchable magnet unit 120 mounts the L-shaped pole members 140 in a different orientation compared to that shown in FIG. 2a. Also, rather than having the fastening holes located entirely within the confines of shorter leg portion 144, these are located in a transition zone 148 between leg portions 142, 144 that comprises an area comparable in size to that of the side face(s) of housing block 124 of unit 120, and disposed such that the longer leg portion 142 is inclined about 45° with respect to the longitudinal axis of unit 120.

It will be noted from FIG. 3b in particular that the inside edge 145 of the shorter L-leg portion 144 includes an angle greater than 90° with the inner edge 143 of longer L-leg portion 142, the edges defining a sharp corner at their juncture. Finally, as may best be seen in FIG. 3a, the longer L-leg portion 142 of the two pole extension members 140 has mounted to their inside edge 143, via flat head screws 149, respective abutment plates 150 that serve the purpose of enlarging the effective magnetic flux transmission area which would otherwise be provided by the narrow webs of the longer L-leg portions 142 of the pole plates 140.

Without wanting to be tied to the following statement, it is believed that the size and arrangement of pole extension members 140 as per the embodiment of FIGS. 3a and 3b provides an improved external magnetic circuit in performing both the sheet fanning and outermost sheet gripping functionality of the EOAT 100 as described below.

It will be also noted that in both embodiments of FIGS. 2 to 4, due to the unitary nature of the pole extension members (also called shoes) 40, 140, both the longer and shorter L-leg portions 42, 142 and 44, 144 provide magnetic flux paths for the magnetic field generated by the single switchable permanent magnet unit 20, 120, and effectively provide a low magnetic reluctance path to extend the N and S-poles, respectively, of the two, cylindrical permanent rare earth magnets of unit 20, 120. In this way, a single pair of L-shaped pole extension members 40, 140 magnetically coupled to the magnetic unit 20, 120 provide distinct magnetic functionalities at different locations of the pole extension members 40, 140, namely a sheet fanning capability and a sheet grabbing (or magnetic coupling) functionality embodied at the two L-leg portions 42, 142 and 44, 144, respectively.

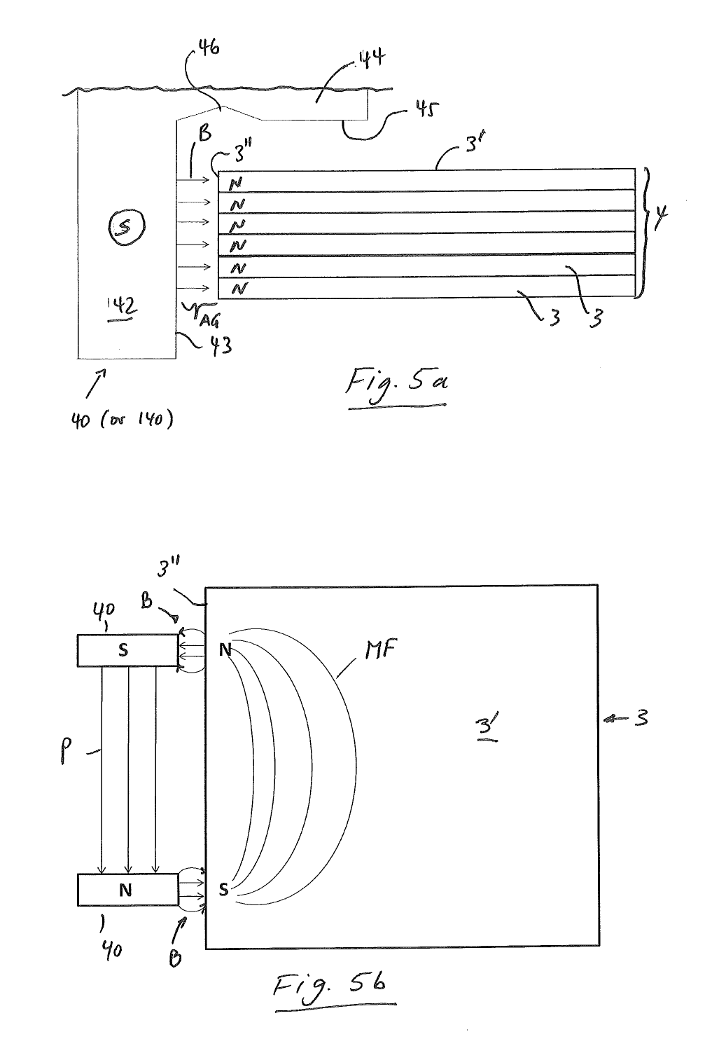

The mode of operation of the EOATs 10, 100 will now be discussed primarily with reference to the simplified and schematic illustrations that make up FIGS. 5a to 5d. FIGS. 5a to 5d are schematic and simplified partial views of the device illustrated in FIG. 4, to illustrate the mode of operation of the fanning and gripping device of FIGS. 2 and 4 (but equally FIGS. 3a, 3b).

FIG. 5a shows a schematic and partial side elevation of one of the pole extension members of the EOAT shown in FIG. 4 (and thus omitting the other components of the device) adjacent the stack of ferromagnetic sheets. FIG. 5b shows a schematic plan view of the magnetic interaction between the (fanning) pole extension shoes of the magnetic device of FIG. 4 and a sheet 3 within the stack 4. FIG. 5c is a further schematic representation similar to FIG. 5a but in which the sheet edges begin to separate (fan) due to magnetic repulsive forces induced by the magnetic fields in the sheets 3 projected by the fanning portions 42 of the pole extension members 40, and FIG. 5d is a schematic representation of the stack 4 as per FIG. 5a, but with the topmost sheet 3 engaging the gripping portion 44 of the pole extension members 40 secured to the switchable permanent magnet unit (not shown) of the magnetic device of FIG. 4.

The switchable permanent magnet unit 20 (120) provides, in an on switching state, an external magnetic field for magnetising of ferromagnetic material, and allows EOAT 10 (100) to separate an upper most sheet 3 from the stack 4 of sheets (as per FIGS. 4 and 5a), by first fanning the sheet edges of the uppermost few sheets of stack 4 (see FIG. 5c), and subsequently magnetically gripping the topmost of the sheets 3 (see FIG. 5d), without interference by or magnetically clamping with the next lower sheet in the stack 4. Thus, device 10 (100) is designed to pick-up a single sheet 3 (ie the topmost) from the stack 4 and subsequently transport it away from the stack 4 for further processing.

The magnetic field generated by unit 20 (120) is made available at and transferred into the uppermost few sheets of the stack 4 via the pair of oppositely magnetisable (or polarizable) pole extension members 40 (140) which are formed from a suitable steel plate material of uniform thickness with high abrasive resistance and high magnetic permeability.

The gantry-suspended robotic arm 8 (FIG. 1) is devised to allow manipulation of the fanning and gripping device 10 (100) and orientate it in space such that the pole extension members 40 (140) can be positioned with their L-arm portions 42, 44 (142,144) in a specific spatial orientation against a lateral side of the stack 4, as illustrated in FIG. 4. This position, the operating position, see also FIGS. 5a to 5d, is characterised by the second (shorter) arm portion 44 (144) of the pole extension members 40 (140) positioning with its horizontal edge 45 (145) closely adjacent (ie hovering) above the upper face 3′ of uppermost sheet 3 of the stack 4 of sheets 3, and extending plane-parallel to uppermost sheet 3, and by the first, longer arm 42 (142) locating opposite the horizontal edges 3″ of the sheets 3, maintaining a small air gap AG between the vertically extending edge 43 (143) of longer first arm portion 42 (142) and the side face of the stack 4.

Activation of the magnet unit 20 (not shown in FIGS. 5a to 5d) causes the two pole extension members 40 to polarize with opposite polarities, thus magnetically inducing the edge zone 3′ of topmost sheet 3 of the stack 4 to fan away from the sheets 3 beneath it, and then be magnetically attracted by and come to rest magnetically secured against the downward facing edge 45 of second arm portion 44 of L-shaped pole extension members 40, thus allowing the gipped sheet 3 to be conveyed away from the stack 4. The ordinary worker in this field will appreciate that using a single integrated EOAT/device 10, 100 to separate (by magnetically fanning) and then individually magnetically gripping and then lifting-away successive sheets from the stack 4 is a more efficient use of floor space and equipment compared to a system using, separate, dedicated sheet fanning devices and dedicated sheet lifter arrangements.

In a first operating step, (see FIGS. 4 and 5a), the robotic arm 8 (not shown) positions magnetic device 10 such that the pole extension members 40 externally mounted to housing block 28 of unit 20 are closely adjacent an upper edge of the stack 4 of sheets 3. FIG. 5a is an enlargement of a single pole extension plate 40 in isolation next to the top sheets of the stack in the interests of clarity. The vertically oriented first leg portion 42 of L-shaped pole extension plate 40 is brought in to close proximity of the horizontally extending edges 3″ of the topmost sheets 3 in the stack 4. The horizontally extending second leg portion 44 of the L-shape pole extension plates 40 extends partially over and parallel the upper surface 3′ of the topmost sheet 3 of the stack 4.

Turning the switchable magnet unit (not shown) induces N and S magnetic polarities in the pole extension plates 40, respectively. The pole extension plate 40 shown in FIG. 5a has an induced south polarity. The high magnetic permeability of the pole extension members 40 directs the magnetic field B across the air gap AG to the edges 3″ of the topmost sheets 3 as this is the lowest reluctance path to complete the magnetic circuit. This induces an opposing polarity (i.e. a polarity opposite that of the adjacent pole member) in edge zones, thus leading to a series of vertically stacked north poles N at the stacked sheets 3. As each sheet of ferromagnetic material 3 is separated by a very small air or lubricant gap (with relatively high reluctance), the magnetic flux MF passes transversely through each individual sheet 3 to the localised south pole, established at the edge portion 3″ directly opposite the other pole extension member, which has a north polarity, see FIG. 5b.

As shown in FIGS. 5a and 5b, this effectively creates a series of vertically stacked bar magnets with north and south poles directly overlying each other. The gap AG between the pole extension members 40 and the edge 3″ of the stacked sheets 3 is small and the axis of polarity P of the magnet (not shown, but located between the N- and S-polarised pole extension plates 40) is parallel to the edge 3″ so that the induced magnetic flux MF in the sheets 3 is strong enough to generate repulsive forces F between adjacent stacked sheets 3. As schematically shown in FIG. 5c, the magnetic repulsion (force vectors F) drive the edge portions 3″ of the topmost sheets 3 apart. Accordingly, the top most sheets 3 separate in a fanning configuration with the upper most sheet 3 moving towards the horizontal face 45 of the second arm portion 44 of the pole extension plates 40.

As the upper most sheet 3 rises towards the horizontal face at edge 45, the flux density of the magnetic field B between the south pole at the arm portion 44 of the pole extension plate 40 and the topmost sheet 3 increases. As the topmost sheet 3 gets closer to the horizontal leg portion 44, the attractive forces generated by the magnetic field B take over from the forces of magnetic repulsion F. This increases the separation between the topmost sheet 3 and the penultimate sheet 3 compared to the separation of the other fanned sheets 3. The skilled worker will understand that the cut out 46 at the juncture between horizontal edge 45 of horizontal arm portion 44 and vertical edge 43 of first leg portion 42 of pole extension plates 40 serves to accommodate the edge 3″ of the topmost sheet 3 as it is drawn into contact with the horizontal arm. 44

Referring to FIG. 5d, when the upper most sheet 3 contacts with its face 3′ the horizontal leg portion 44, a strong magnetic circuit forms between the two pole extension members 40 through the attached sheet 3. This strong circuit shunts magnetic flux away from the vertical leg portion 42 of the pole extension plates 40. In turn, the induced magnetic flux MF in the edge regions 3″ of the remaining sheets 3 (see FIG. 5b) is significantly reduced. Accordingly, the repulsive forces F between the stacked sheets 3 reduces and the previously fanned sheets 3 (see FIG. 5c) briefly collapse back to a stacked configuration. The increased flux B at the upper leg portion 44 securely holds (ie grips) the topmost sheet 3 so that it can then be completely lifted away by the robotic arm (not shown), if the rating of the magnet unit 20 is sufficient for this purpose. To detach the sheet 3 from the pole extension plates 40, the magnet unit 20 (not shown) is simply deactivated and the induced flux B collapses and attractive forces become negligible.

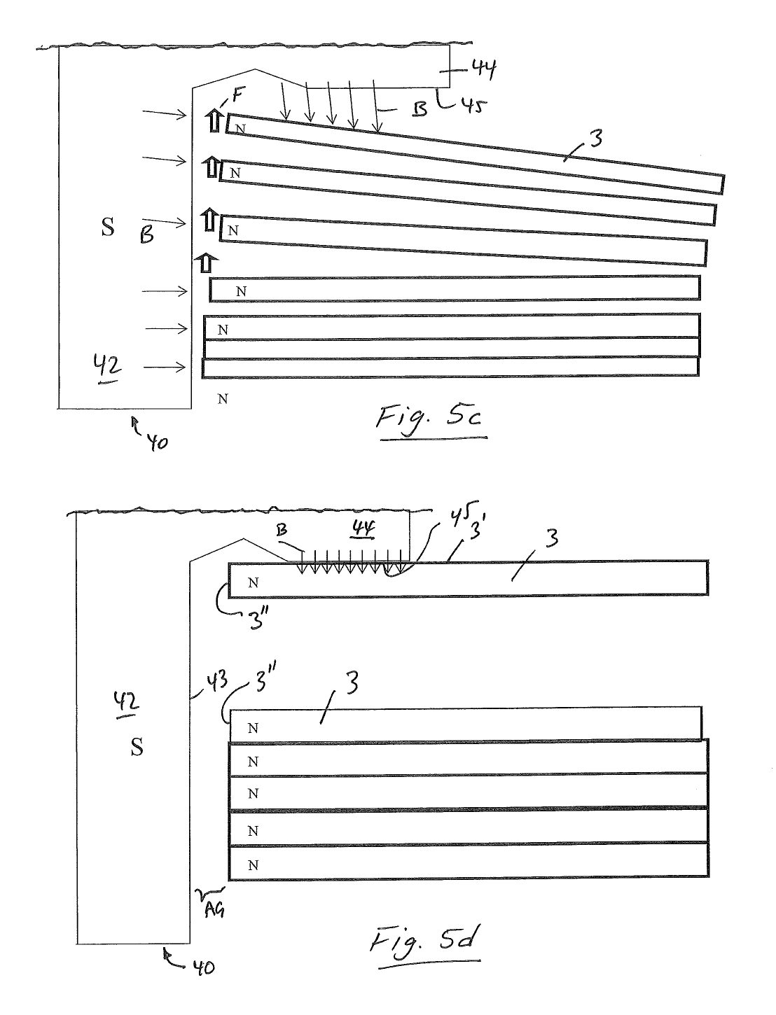

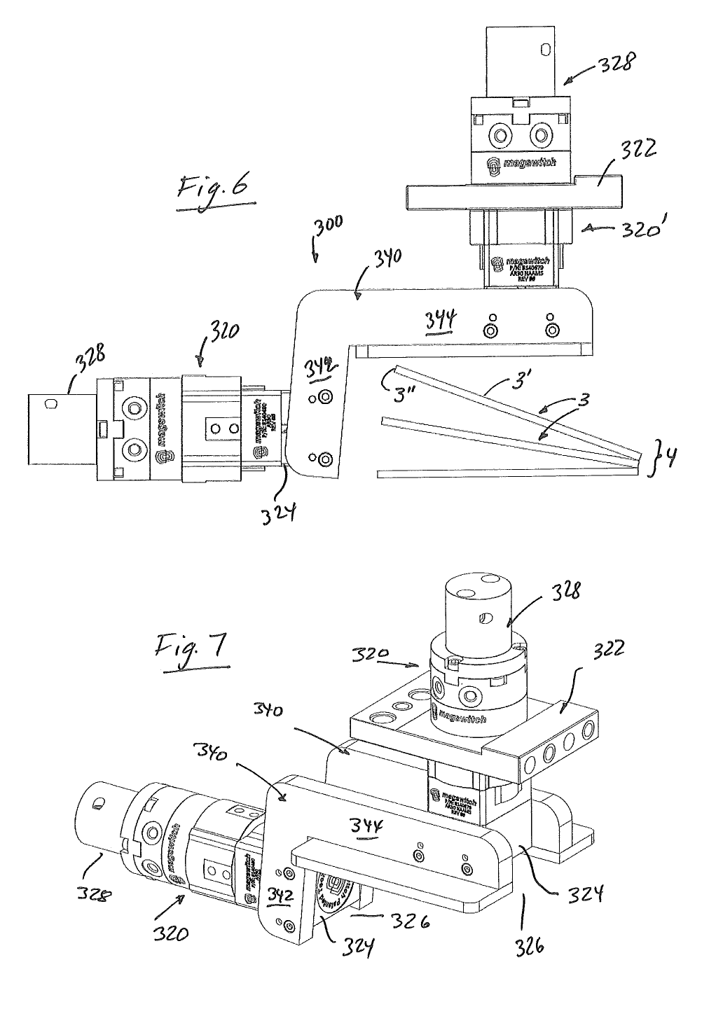

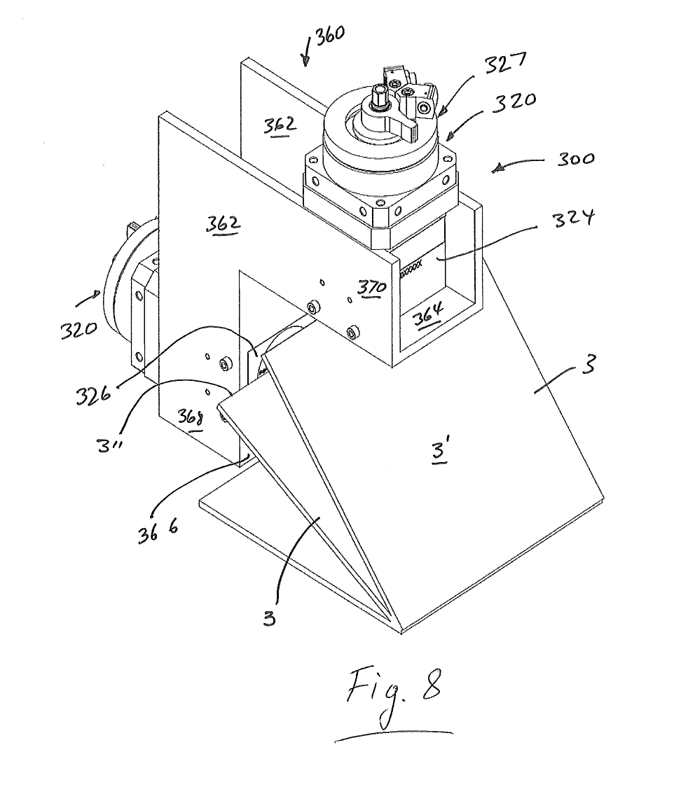

FIGS. 6 to 8 show two further but similar embodiments in which the EOAT (magnetic device) 300 has two magnet units 320 of identical configuration to the one previously described with reference to FIGS. 1 to 4. In the illustrated embodiment according to FIGS. 6 and 7, only one switchable magnetic unit 320 comprises a mounting member in form of a plate mount 322 similar to that shown in FIGS. 3a and 3b by way of which the EOAT unit 300 can be secured to coupling unit at robotic arm (not shown). In the other embodiment, FIG. 8, the coupling unit has been omitted altogether. The skilled person will of course appreciate that such mounting components, which can be made from non-ferrous metals or non-magnetisable steel, can be mounted to either the switchable magnet units 320 themselves, or the magnetic pole extension plates or structure 340 illustrated in FIG. 8.

In the embodiment of FIG. 8, a support structure comprised on an essentially L-shaped cradle 360 with two parallel extending, L-shaped side plates 362 of non-ferromagnetic material, spaced apart and connected to each other through web portions 364, 366 respectively located near the terminal ends of the two perpendicular arm portions 368, 370 of side plates 362, is provided to support the two switchable magnet units 320, one at each arm portion 368, 370. The lower terminal faces of the magnet units 320, which provide the dipole working air gap 326 of the units 320 (and form part of the N- and S-polarisable side wall portions of the housing block of units 320 as was described with reference to FIG. 2a/2b) for attachment or magnetic interaction with the ferromagnetic sheets 3, come to lie flush with the inward facing edges of arm portions 368, 370.

Whilst at first glance it may appear that L-shaped side plates 362 provide external (or additional) pole extension members as previously described with reference to the embodiments of FIGS. 2 to 4, this is not the case. Rather, the L-shaped cradle structure 360 serves to fix the relative spatial orientation of the respective terminal air gap faces 326 of the two magnet units 320 with respect to one another and so as to extend perpendicular to one another. In this embodiment, one of the magnet units 320 provides for the fanning functionality previously described, whereas the other magnet unit 320 serves to magnetically grip and secure at its working air gap face 326 the uppermost sheet 3 fanned away from the lower sheets 3, when the unit 320 is turned into the (magnetic filed emitting) on state.

In contrast, in the embodiment of FIG. 7, the skilled worker will note the similarity of shape and configuration of the two parallel spaced apart L-shaped plate members 340 when compared with the pole extension plates 140 of the embodiment of FIG. 3. In this embodiment, rather than having a single switchable magnet unit provide a magnetic flux source for both the fanning and gripping functionality of the EOAT 300, two units 320, 320′ identical to those previously described are used, one (320′) located close to the terminal ends of the longer arms 342 and one (320) located close to the terminal ends of the shorter arms 344 of the ferromagnetic material pole extension members 340 between which the magnet units 320, 320′ locate. One may note that in this embodiment, the fanning pole extension arms 342 are the shorter L-legs of plate members 340, whereas the longer (upper) L-leg portion 344 provides the gipping functionality in conjunction with its local switchable magnetic unit 320′.

Noting the relatively large and distal separation of magnet units 320 and 320′ at the EOAT 300, and the individual activation of the fanning capability and the gripping capability provided at the respective separate switchable magnet units 320, 320′ by way of the respective stepper actuators 328, magnetic circuits will be created in preference in the immediate vicinity of the magnet units 320 320′ and the adjacent zones of the arms 342, 344 of L-shaped plate members 340, so that a better adjusted fanning and gripping functionality can be achieved, not only through variation of geometries of ferromagnetic components of the EOAT 300 that form part of the magnetic circuit formed when in proximity or abutment with a single sheet or a stack of sheets, but also by selecting differently rated switchable magnet units 320, 320′ from the stand point of field generation strength and flux density at or near the respective working air gaps 326 of the two units 320, 320′.

The ordinary worker will thus appreciate that embodiments of the magnetic device (EOAT) 300 which incorporate two (or more) magnet units 320, 320′ for separately generating magnetic fields to perform the fanning and the gripping functionality, respectively, need not have each the L-shaped pole extension members described with reference to FIGS. 2 to 5. Instead, the magnet units 320, 320′ can be are supported by an L-shaped support or carrier structure of non-magnetic or ferromagnetic material, as long as the axis of polarity at the working air gaps of each unit 320 is located to extend perpendicular to the sheets 12 in order to perform the fanning and lifting operations.

The benefits and advantages of an integrated sheet fanning and lifting device will be readily apparent to workers in this field. These specific embodiments described above merely illustrate the scope and applicability of the present invention. Skilled workers will readily recognise many other variations and modifications which do not depart from the spirit and scope of the broad inventive concept.

1. Sheet fanning device for use in fanning-away an outer most sheet from a stack of ferromagnetic sheet material, comprising: a carrier structure with a mount for attaching the device as an end-of-arm-tool (EOAT) to a robotic arm arranged for moving and positioning the EOAT between an operating position adjacent a side of a stack of ferromagnetic sheets and a remote position removed from the stack of ferromagnetic sheets; a magnetic fanning arrangement supported at the carrier structure, the fanning arrangement comprising an on-off switchable magnet unit and a pair of fanning pole extension members magnetisable by the switchable magnet unit with opposite polarities, the fanning pole extension members spaced apart and configured such that when in the operating position of the EOAT these face the side of the stack of sheets and dimensionally extend over a length equal or grater than at least the thickness of the outermost and next underlying sheet of the stacked sheets, the switchable magnet being switchable into an on state in which magnetic fields of like orientation are induced by the fanning pole shoes in overlapping sections of edge regions of the outermost and the next underlying sheet and repulsive forces are generated in a direction perpendicular to the induced magnetic fields, seeking to lift the edge region of the outermost sheet away from the underlying sheet by magnetic repulsion.

2. A sheet fanning device according to claim 1, further comprising a sheet gripping arrangement supported at the carrier structure and arranged for contacting a face of the fanned-out outermost sheet and secure this sheet to the EOAT for retrieval thereof upon the EOAT being displaced from its operative position away from the stack of sheets

3. The sheet fanning device of claim 1, wherein the sheet gripping arrangement comprises the or a further on-off switchable magnet unit and abutment pole extension members magnetisable by the switchable magnet unit with opposite polarities, the abutment pole extension members located in relation to the fanning pole extension members such that upon the outermost sheet being fanned away from the stack by the fanning pole extension members, it is magnetically attracted and secured to the abutment pole extension members when the magnet unit is in the on position.

4. The sheet fanning device of claim 2, wherein the fanning and gripping arrangement comprise a common pair of pole extension members and a single said switchable permanent magnet unit for imparting opposite polarities to the two pole extension members.

5. The sheet fanning device of claim 3, wherein the pole extension members have an L-shaped form, and preferably are plate-like.

6. The sheet fanning device of claim 2, wherein the carrier structure comprises a plate-like or ring-like structure fixed to a housing block of the switchable magnet unit, and wherein the fanning and abutment pole extension members are removably secured to the housing block.

7. The sheet fanning device of claim 1, wherein the switchable magnets units comprise switchable permanent magnets switchable between an on state in which an external magnetic field is present between the fanning and abutment pole extension members, and an off state in which no magnetic attraction is experienced at the fanning pole extension members.

8. A magnetic sheet fanning and gripping device for magnetically unstacking and magnetically gripping an outermost sheet material from a stack of ferromagnetic sheet material, comprising:
a support structure with a coupling for releasable securing of the fanning and gripping device to a positioning device arranged for bringing the fanning and gripping device in alignment with a lateral side of a stack of ferromagnetic sheets;
a pair of ferromagnetic fanning pole extension members carried by the support structure, each fanning pole extension member having a longitudinal extension sufficient to span at least a number of uppermost stacked sheets when brought in facing relationship with the side of the stack of sheets;
a pair of ferromagnetic gripping pole extension members carried by the support structure, each gripping pole extension member having an abutment face angled with respect to the longitudinal extension of the fanning pole extension member and of a length sufficient to extend past the sheet edge and span part of a face of the sheets, the abutment face operative to receive and magnetically secure the outermost sheet of the stack of ferromagnetic sheets; and
an on-off switchable magnet arrangement for magnetizing one of the pole extension members from each of the pair of fanning and gripping pole extension members with the same polarity and the other one of the pole extension members of each of the pairs to have the opposing polarity;
the device operative such that switching the magnet arrangement into an on-position and bringing the pair of fanning pole extension members in close facing proximity to the sheet edges at the side of the stacked sheets (i) induces a north-south magnetic field in the edge regions of at least the outer most and the next underlying sheet of the stack, (ii) sets up repulsive forces between the sheets tending to fan the outer most sheet from the stack away from the next underlying sheet along the longitudinal extension of the fanning pole extension members and (iii) urges the outer most sheet into contact with the abutment faces of the attachment pole shoes thereby securing the outermost sheet magnetically to the support structure for removal thereof upon displacement of the fanning and gripping device by the positioning device.

9. The magnetic sheet fanning and gripping device of claim 8, wherein the on-off switchable magnet arrangement comprises two on-off switchable magnet units, one of the magnet units for magnetizing the gripping pole extension members and the other magnet unit for magnetizing the fanning pole extension members such that fanning and gripping functionality of the device are selectable independent or synchronised.

10. The magnetic sheet fanning and gripping device according to claim 8, wherein the on-off switchable magnet arrangement comprises a single on-off switchable magnet unit configured to magnetize a single pair of pole extension members that comprise the respective pairs of gripping and fanning pole extension members, with opposing polarities.

11. The magnetic sheet fanning and gripping device of claim 8, wherein one of the gripping pole extension members and one of the fanning pole extension members are integrally formed and the other one of the gripping pole extension members and the other one of the fanning pole extension members are integrally formed, and wherein the two integral pole extension members are magnetically isolated from one another and arranged to be polarised with opposite polarities by the switchable magnet unit.

12. The magnetic sheet fanning and gripping device according to claim 8, wherein the pair of gripping pole extension members and the pair of fanning pole extension members are integrally formed with one another.

13. The magnetic sheet fanning and gripping device according to claim 12, wherein the gripping and fanning pole extension members are provided by two L-shaped ferromagnetic metal plates.

14. The magnetic sheet fanning and gripping device according to claim 8, wherein the support structure is attached or forms part of the switchable magnet unit.

15. The magnetic sheet fanning and gripping device according to claim 8, wherein the on-off switchable magnet arrangement comprises on-off switchable permanent magnet units.

16. A magnetic sheet material de-stacker comprising a positioning device and a magnetic sheet fanning and gripping device according to claim 8.

17. The de-stacker of claim 15, wherein the positioning device is a robotic arm mounted to an overhead gantry.

18. The sheet fanning device of claim 4, wherein the pole extension members have an L-shaped form, and preferably are plate-like.

19. The sheet fanning device of claim 3, wherein the carrier structure comprises a plate-like or ring-like structure fixed to a housing block of the switchable magnet unit, and wherein the fanning and abutment pole extension members are removably secured to the housing block.

20. The sheet fanning device of claim 4, wherein the carrier structure comprises a plate-like or ring-like structure fixed to a housing block of the switchable magnet unit, and wherein the fanning and abutment pole extension members are removably secured to the housing block.
